(19) United States
(12) Patent Application Publication
(10) Pub. No.: US 2022/0122571 A1
(43) Pub. Date: Apr. 21, 2022

(54) CLOCK

(71) Applicant: Edgar Davin Salatandre, Toronto (CA)

(72) Inventor: Edgar Davin Salatandre, Toronto (CA)

(21) Appl. No.: 17/567,802

(22) Filed: Jan. 3, 2022

Related U.S. Application Data
(63) Continuation of application No. 16/059,897, filed on Aug. 9, 2018, now abandoned.
(60) Provisional application No. 62/544,063, filed on Aug. 11, 2017.

(51) Int. Cl. G10H 1/26; G04G 13/00

(52) U.S. Cl. CPC G10H 1/26; G10H 2220/411; G04G 13/00

(57) ABSTRACT

An apparatus for use with a clock body, a clock movement having an hour hand and a sound chip. The apparatus includes a system which is operatively coupled to the clock body, is in receipt of a sound chip, and is adapted to be triggered periodically by a clock movement to produce a sound.

### CROSS-REFERENCE TO RELATED APPLICATION

This application is a continuation application based on U.S. patent application Ser. No. 16/059,897, filed Aug. 9, 2018 entitled “Clock” which claims the benefit of U.S. Provisional Patent Application Ser. No. 62/544,063, filed Aug. 11, 2017.

### BACKGROUND OF THE INVENTION

1. Field of the Invention

The invention relates to the field of clocks.

2. Prior Art

It is known to produce electronic clocks. It is also known in the field of electronic clock production for manufacturers to purchase semiconductor chips preprogrammed to produce a chime on the hour.

### SUMMARY OF THE INVENTION

Forming one aspect of the invention is apparatus for use with a clock body, a clock movement having an hour hand and a sound chip, the apparatus comprising:

a system which, in use:
is operatively coupled to the clock body
is in receipt of the sound chip and
is adapted to be triggered periodically by the clock movement, to produce a sound.

According to another aspect of the invention, the system can include a module, the module being adapted to releasably receive the sound chip to provide for said receipt of the sound chip by the system.

According to another aspect of the invention, the system can further comprise a sound knob and can be adapted to vary the volume of the chime in use based upon movement of the sound knob.

According to another aspect of the invention, the system can further comprise a light sensor and can be adapted to suspend the chime in the absence of a predetermined amount of light.

According to another aspect of the invention is a combination including the system in use with a clock body; a clock movement having an hour hand; and a sound chip.

According to another aspect of the invention, in the combination, the clock movement can further comprise a minute hand.

Advantages, features and characteristics of the invention will become apparent upon a review of the following detailed description with reference to the appended drawings, the latter being briefly described hereinafter.

### BRIEF DESCRIPTION OF THE DRAWINGS

FIG. 1 is a front view of apparatus according to an exemplary embodiment of the invention in use;

FIG. 2 is a rear view of the structure of FIG. 1; and

FIG. 3 is a side, rear view of the structure of FIG. 1.

### DETAILED DESCRIPTION OF THE PREFERRED EMBODIMENTS

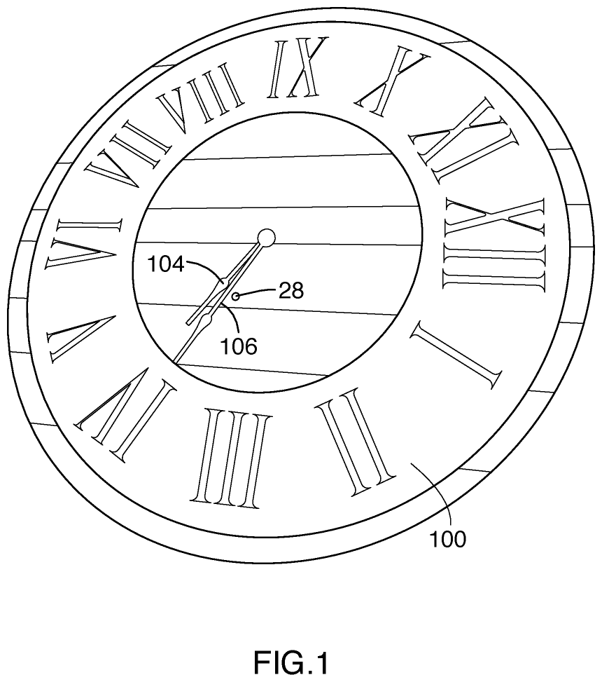

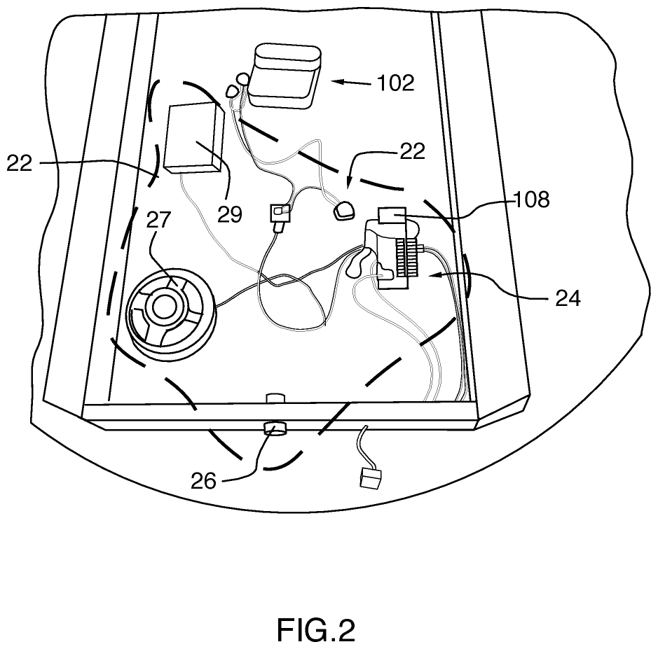

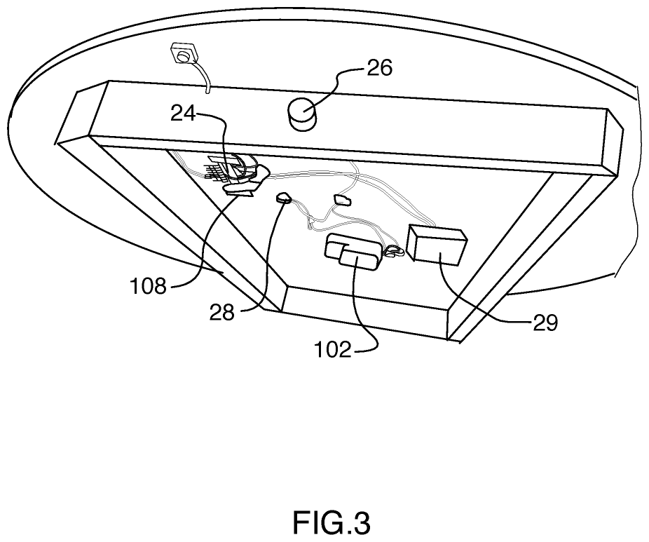

As an initial matter, the apparatus according to the exemplary embodiment as aforementioned will be understood to be for use with, as identified in FIGS. 1-3:
a clock body 100
a clock movement 102 having an hour hand 104 and a minute hand 106 and adapted to emit a signal on the hour; and
a sound chip 108.

The apparatus 20 according to the exemplary embodiment is also shown in FIGS. 1-3 and will be seen to include a system 22, the system 22 including:
a module 24 adapted to releasably receive the sound chip;
a sound knob 26; and
a light sensor 28.

In use:

the system 22 is operatively coupled to the clock body 100, the clock movement 102 and the sound chip 108, to define a clock 32
the light sensor 28 is operatively coupled to the clock body 100 so as to be exposed to ambient light when the clock 32 is in use
the clock movement periodically emits the signal which triggers system 22 and produces a sound—when the light sensor 28 is exposed to at least a predetermined amount of said ambient light—the volume of such sound being a function of the sound knob 26.

Persons of ordinary skill will readily appreciate the advantage of the foregoing, to wit, the invention allows clocks to be produced in various forms with customizable chimes.

Whereas a specific embodiment is herein shown and described, variations are possible. Accordingly, the invention should be understood to be limited only by the accompanying claims, purposively construed.

What is claimed is:

1. Apparatus for use with a clock body, a clock movement having an hour hand and a sound chip, the apparatus comprising:
a system which, in use,
is operatively coupled to the clock body,
is in receipt of the sound chip, and
is triggered periodically by the clock movement, to produce a sound, the system including a module, the module, in use, releasably receiving the sound chip to provide for said receipt of the sound chip by the system.

2. Apparatus according to claim 1, wherein the system further comprises a sound knob which, in use, varies a volume of a chime in use based upon movement of the sound knob.

3. Apparatus according to claim 1, wherein the system further comprises a light sensor and, in use, suspends a chime in an absence of a predetermined amount of light.

4. In combination:
a clock body;
a clock movement having an hour hand;
a sound chip; and
the apparatus of claim 1 in use with the clock body, the clock movement and the sound chip.

5. The combination of claim 4, wherein the clock movement further comprises a minute hand.
